(19) United States
(12) Patent Application Publication
(10) Pub. No.: US 2011/0256369 A1
(43) Pub. Date: Oct. 20, 2011

(54) THIN-LAYERED ALTERNATING MATERIAL BODY SUPPORT AND METHOD OF MANUFACTURING SAME

(76) Inventors: Stephen Switzer, Kingsport, TN (US); Chris Glover, Kingsport, TN (US)

(21) Appl. No.: 13/141,386

(22) PCT Filed: Dec. 18, 2009
(86) PCT No.: PCT/US09/68817

§ 371 Date: Jun. 22, 2011

Related U.S. Application Data
(60) Provisional application No. 61/139,968, filed on Dec. 22, 2008.

(51) Int. Cl. B32B 3/26; A47C 27/00; B32B 7/02

(52) U.S. Cl. 428/215; 428/316.6; 428/213

(57) ABSTRACT

A body support assembly comprising a first layer comprising a visco-elastic foam (e.g., a non-reticulated foam), a second layer supporting the first layer and comprising a non-visco-elastic foam (e.g., a latex foam), and a third layer supporting the second layer and comprising a visco-elastic foam (e.g., a non-reticulated foam). In one embodiment, a thickness of the first layer is less than 20% (preferably less than 10%) of a total thickness of the body support assembly, and a combined thickness of all visco-elastic layers is less than 50% of the total thickness. Preferably, the thickness of the first layer is less than 3 centimeters. The body support assembly includes a first layer comprising non-reticulated, visco-elastic foam, a second layer comprising a material different than non-reticulated, visco-elastic foam, a third layer comprising visco-elastic foam, a fourth layer comprising a material different than non-reticulated, visco-elastic foam, and a fifth layer comprising visco-elastic foam.

### CROSS-REFERENCE TO RELATED APPLICATIONS

Priority is hereby claimed to U.S. Provisional Patent App. No. 61/139,968, filed Dec. 22, 2008, the entire contents of which is herein incorporated by reference.

### BACKGROUND

Conventional body supports can be found in a wide variety of shapes and sizes, and are often adapted for supporting one or more body parts of a user. As used herein, the term “body support” includes without limitation any deformable element adapted to support one or more parts or all of a human or animal in any position. Examples of body supports include mattresses, pillows, and cushions of any type, including those for use in beds, seats, and in other applications.

Many body supports are constructed entirely or partially out of foam material. For example, polyurethane foam is commonly used in many mattresses, pillows, and cushions, and can be used alone or in combination with other types of cushion materials. In many body supports, visco-elastic material is used, providing the body support with an increased ability to conform to a user and to distribute the weight or other load of the user. Some visco-elastic body support materials are also temperature sensitive, thereby also enabling the body support to change shape based in part upon the reception of body heat received from the supported body part.

Although the number and types of body supports constructed with one or more visco-elastic materials continue to increase, the capabilities of such materials are often underutilized. In many cases, this underutilization is due at least in part to the design of the body support and/or the choice of material(s) used in various locations of the body support.

Based at least in part upon the limitations of existing body supports and the high consumer demand for improved body supports having visco-elastic material in a wide variety of applications, new body supports are welcome additions to the art.

### SUMMARY

The present invention provides a body support assembly comprising a first layer comprising a visco-elastic foam (e.g., a non-reticulated, visco-elastic foam), a second layer supporting the first layer and comprising a non-visco-elastic foam (e.g., a latex foam), and a third layer supporting the second layer and comprising a visco-elastic foam (e.g., a non-reticulated, visco-elastic foam). In one embodiment, a thickness of the first layer is less than 20% (e.g., less than 10%, preferably about 7%) of a total thickness of the body support assembly, and a combined thickness of all visco-elastic layers is less than 50% of the total thickness. Preferably, the thickness of the first layer is less than 3 centimeters, and more preferably less than 2 centimeters.

In another aspect, the present invention provides a body support assembly comprising a first layer comprising non-reticulated, visco-elastic foam, a second layer supporting the first layer and comprising a material different than non-reticulated, visco-elastic foam (e.g., a latex foam), a third layer supporting the second layer and comprising visco-elastic foam (e.g., a non-reticulated, visco-elastic foam), a fourth layer supporting the third layer and comprising a material different than non-reticulated, visco-elastic foam (e.g., a high-resiliency foam), and a fifth layer supporting the fourth layer and comprising visco-elastic foam. In one embodiment, a thickness of the first layer is less than 20% (e.g., less than 10%, preferably about 7%) of a total thickness of the body support assembly, and a combined thickness of all visco-elastic layers is less than 50% of the total thickness. Preferably, the thickness of the first layer is less than 3 centimeters, and more preferably less than 2 centimeters (e.g., 1 centimeter).

In some embodiments, a body support is provided, and comprises a first (top) layer of foam comprising a first material, a second layer of foam adjacent the first layer and comprising a second material different from the first material, and a third layer of foam adjacent the second layer, spaced from the first layer, and comprising a third material different from the second material. The first and third layers of material in such embodiments can comprise visco-elastic foam. Also, in some embodiments the second layer can comprise latex foam. The mattress can further include a fourth layer of foam adjacent the third layer and spaced from the first and second layers, wherein the fourth layer comprises a fourth material different from the third material, a fifth layer of foam adjacent the fourth layer, spaced from the first, second and third layers, and comprising a fifth material different from the fourth material, and a sixth layer of foam adjacent the fifth layer, spaced from the first, second, third and fourth layers, and comprising a sixth material different from the fifth material.

Some embodiments of the present invention provide a mattress having a first (top) layer of foam comprising a first material and defining a thickness of no greater than about two centimeters, a second layer of foam adjacent the first layer of foam and comprising a second material different from the first material and defining a thickness of no greater than about two centimeters (and in some embodiments, no greater than about 1 centimeter), a thin adhesive layer positioned between the first layer and the second layer to couple the first layer to the second layer, and a third layer of foam positioned adjacent the second layer and spaced from the first layer; wherein the third layer comprising a third material different from the second material and defining a thickness of less than about two centimeters. The first and third layers of material in such embodiments can comprise visco-elastic foam

In some embodiments, a mattress is provided, and includes a first layer of foam comprising visco-elastic foam, latex foam or conventional foam, a second layer of foam comprising a different one of such foams coupled to the first layer of foam, and a third layer of foam consisting of visco-elastic foam, latex foam or conventional foam different from the foam of the second layer, wherein the third layer is coupled to the second layer and spaced from the first layer.

Further aspects of the present invention, together with the organization and operation thereof, will become apparent from the following detailed description of the invention when taken in conjunction with the accompanying drawings, wherein like elements have like numerals throughout the drawings.

### BRIEF DESCRIPTION OF THE DRAWINGS

FIG. 1 is a perspective view of a body support according to some embodiments of the present invention.

FIG. 2 is a cross-sectional view of the body support shown in FIG. 1 according to a first embodiment of the present invention, taken along line 2-2 of FIG. 1.

FIG. 3 is a cross-sectional view of the body support shown in FIG. 1 according to a second embodiment of the present invention, also taken along line 2-2 of FIG. 1.

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. In addition, terms such as “first”, “second”, and “third” are used herein and in the appended claims for purposes of description and are not intended to indicate or imply relative importance or significance. The term “first” does not necessarily refer to the top most layer, rather, it refers to the first of a plurality, without indicating a particular location or position.

The use of “including,” “comprising,” or “having” and variations thereof herein is meant to encompass the items listed thereafter and equivalents thereof as well as additional items. Also, unless limited otherwise, the terms “mounted”, “connected,” “supported” and “coupled,” and variations thereof herein are used broadly and encompass direct and indirect connections and couplings. In addition, the terms “connected” and “coupled” and variations thereof are not restricted to physical or mechanical connections or couplings.

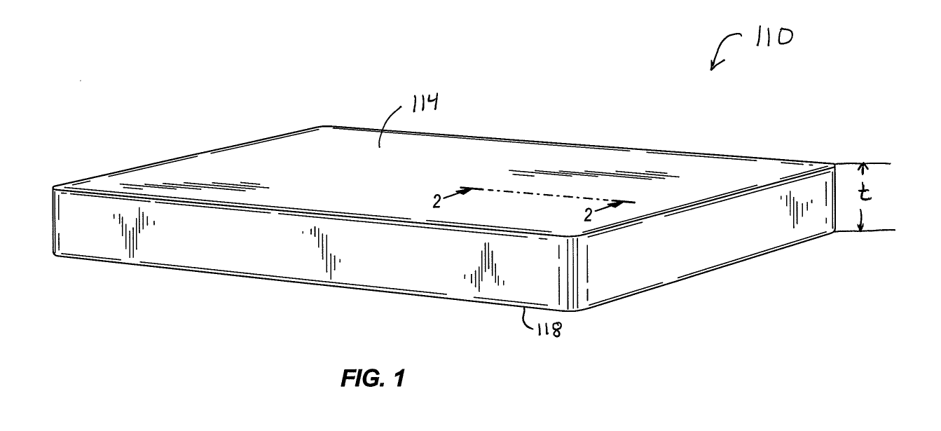

A body support 110 according to an embodiment of the present invention is illustrated in FIG. 1 and comprises a top surface 114, a bottom surface 118, and a thickness between the top surface 114 and the bottom surface 118 denoted by t.

In the illustrated embodiment of FIG. 1, the top surface 114 and the bottom surface 118 are substantially planar. In other, non-illustrated embodiments, either or both of the top and bottom surfaces 114, 118 can be non-planar, including without limitation surfaces having ribs, bumps, waves, and other protrusions of any shape and size, surfaces having grooves and other apertures, and the like.

The body support 110 can include a plurality of layers of foam (not shown in FIG. 1, in which the layers are hidden from view by a body support cover). The plurality of layers of foam can interact to provide a soft and comfortable feel, while providing adequate support for the user. In some embodiments, the plurality of layers of foam include two or more layers of visco-elastic foam alternating with other types of foam (e.g., latex, standard polyurethane foam, or any expanded polymer (e.g., expanded ethylene vinyl acetate, polypropylene, polystyrene, or polyethylene)) to provide the body-conforming and low resilience benefits of viscoelastic foam while also exhibiting the “bounce” and overall support of conventional body supports.

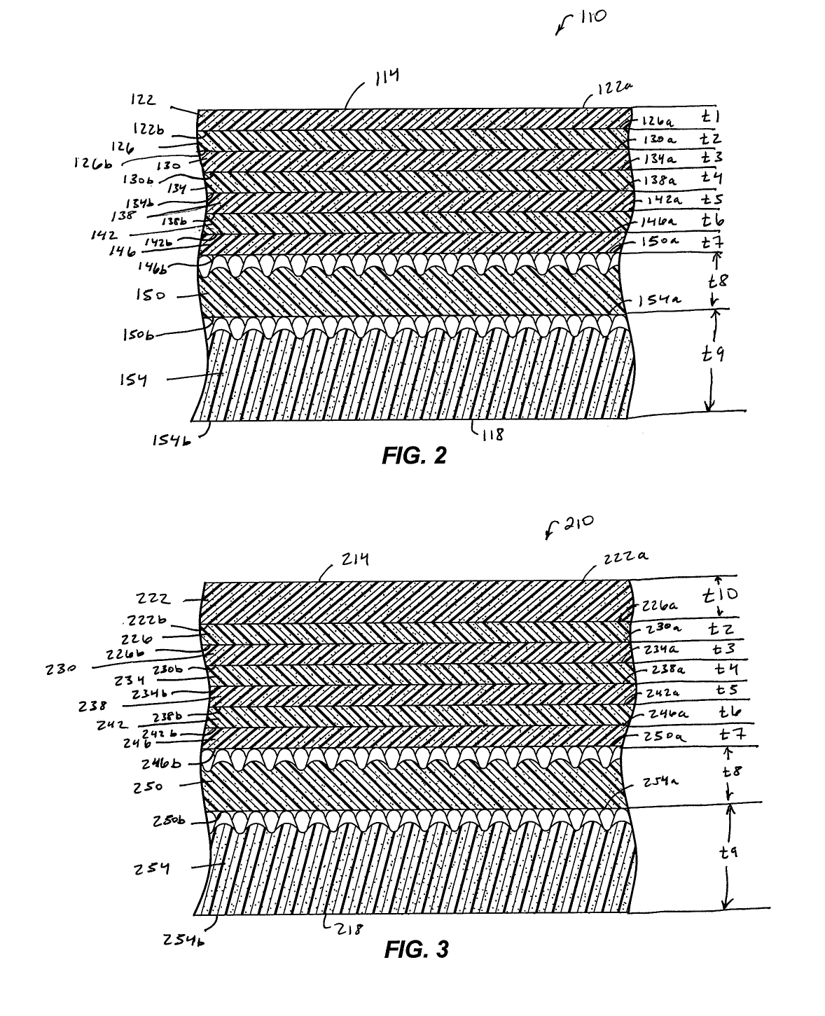

One such embodiment is illustrated in FIG. 2, and includes a plurality of layers of foam in stacked relation. A first layer 122 includes a first top surface 122a and a first bottom surface 122b. In the illustrated embodiment, the first top surface 122a is also the top surface 114 of the body support 110. In other embodiments, a pad, topper or one or more other layers can be positioned on top of the first top surface 122a. In the illustrated embodiment of FIG. 1, both the first top surface 122a and the first bottom surface 122b are substantially planar. In other embodiments, at least one of the first top surface 122a and the first bottom surface 122b can be non-planar, including without limitation surfaces having ribs, bumps, and other protrusions of any shape and size, surfaces having grooves and other apertures that extend partially or fully through the first layer 122, and the like.

The first layer 122 defines a first thickness t1 between the first top surface 122a and the first bottom surface 122b. In some embodiments, t1 is less than or equal to about 3 centimeters (cm). In other embodiments, t1 is less than or equal to about 2 cm. In still other embodiments, t1 is less than or equal to about 1 cm.

The first layer 122 can comprise reticulated or non-reticulated visco-elastic foam (sometimes referred to as “memory foam” or “low resilience foam”). Coupled with the slow recovery characteristic of the visco-elastic foam, the first layer 122 can at least partially conform to a user's body, thereby distributing the force applied by the user's body upon the first layer 122. The first layer 122 can provide a relatively soft and comfortable surface for a user's body or body portion (hereinafter referred to as “body”). In some embodiments, the first layer 122 comprises a non-visco-elastic foam.

In some embodiments, the first layer 122 of visco-elastic foam has a hardness of at least about 20 N and no greater than about 80 N for desirable softness and body-conforming qualities. In other embodiments, the first layer 122 has hardness of at least about 30 N and no greater than about 70 N for this purpose. In still other embodiments, a first layer 122 viscoelastic foam hardness of at least about 40 N and no greater than about 60 N is utilized. Unless otherwise specified, the hardness of a material referred to herein is measured by exerting pressure from a plate against a sample of the material to a compression of 40% of an original thickness of the material at approximately room temperature (e.g., 21-23 Degrees Celsius), wherein the 40% compression is held for a set period of time, following the International Organization of Standardization (ISO) 2439 hardness measuring standard.

The first layer 122 can also have a density providing a relatively high degree of material durability. The density of the foam in the first layer 122 can also impact other characteristics of the foam, such as the manner in which the first layer 122 responds to pressure, and the feel of the foam. In some embodiments, the first layer 122 has a density of no less than about 30 kg/m³ and no greater than about 150 kg/m³. In other embodiments, a first layer 122 having a density of at least about 40 kg/m³ and no greater than about 135 kg/m³ is utilized. In still other embodiments, a first layer 122 having a density of at least about 50 kg/m³ and no greater than about 120 kg/m³ is utilized.

With continued reference to the illustrated embodiment of FIG. 2, the first layer 122 of the illustrated body support 110 comprises a cellular structure of flexible visco-elastic polyurethane foam in which the walls of the individual cells are substantially intact (i.e. non-reticulated visco-elastic polyurethane foam). In other non-illustrated embodiments, the first layer 122 of the body support 110 can comprise reticulated visco-elastic foam. Reticulated visco-elastic foam has characteristics that are also well suited for use in the body support 110, including the enhanced ability to permit fluid movement through the reticulated visco-elastic foam, thereby providing enhanced air and/or heat movement within, through, and away from the first layer 122. Reticulated foam is a cellular foam structure in which the cells of the foam are essentially skeletal. In other words, the cells of the reticulated foam are each defined by a plurality of apertured windows surrounded by cell struts. The cell windows of reticulated foam can be entirely gone (leaving only the cell struts) or substantially gone. In some embodiments, the foam is considered “reticulated” if at least 50% of the windows of the cells are missing (i.e., windows having apertures therethrough, or windows that are completely missing and therefore leaving only the cell struts). Such structures can be created by destruction or other removal of cell window material, or preventing the complete formation of cell windows during the manufacturing process of the foam.

The illustrated embodiment of FIG. 2 further includes a second layer 126 that includes a second top surface 126a and a second bottom surface 126b. The second top surface 126a can be positioned adjacent the first bottom surface 122b, such that the second layer 126 supports the first layer 122. In some embodiments, the first layer 122 can rest upon the second layer 126 without being secured thereto. However, in other embodiments, the first and second layers 122, 126 are secured to one another by adhesive or cohesive bonding material, and/or by being bonded together during formation of the first and second layers 122, 126. The coupling mechanism can include, but is not limited to tape, hook and loop fastener material, conventional fasteners, stitches extending at least partially through the first and second layers 122, 126, or any suitable manner. In the illustrated embodiment of FIG. 2, thin adhesive strips (not shown) are positioned between the first layer 122 and the second layer 126. The adhesive strip material can extend across the entire width and length of the body support 110, or in some embodiments can instead be located in less than all the surface area defining the interface between the first and second layers 122, 126. For example, the adhesive strip material can be located only at edges of the body support 110 to edge adhere the first and second layers 122, 126 together, can be located at discrete locations across the length and/or width of the body support 110 to spot adhere the first and second layers 122, 126 together, or can be located in any other manner to secure the first and second layers 122, 126 together. The thin adhesive strips can be flexible enough to form a softer structure than other, more conventional adhesive glues.

In the illustrated embodiment, both the second top surface 126a and the second bottom surface 126b are substantially planar. In other embodiments, at least one of the second top surface 126a and the second bottom surface 126b can be non-planar, including without limitation surfaces having ribs, bumps, and other protrusions of any shape and size, surfaces having grooves, and other apertures that extend partially or fully through the second layer 126, and the like, and the like.

The second layer 126 defines a second thickness t2 between the second top surface 126a and the second bottom surface 126b. In some embodiments, t2 is less than or equal to about 3 cm. In other embodiments, t2 is less than or equal to about 2 cm. In still other embodiments, t2 is less than or equal to about 1 cm. In some embodiments, t2 is substantially equal to t1.

In some embodiments, the second layer 126 comprises latex foam having a hardness of at least about 30 N and no greater than about 130 N for a desirable overall body support firmness and “bounce” when used in conjunction with the layer of visco-elastic foam 122 described above. In other embodiments, the second layer 126 has hardness of at least about 40 N and no greater than about 120 N for this purpose. In still other embodiments, a second layer latex foam hardness of at least about 50 N and no greater than about 110 N is utilized.

In some embodiments, the second layer 122 of latex foam has a density of no less than about 40 kg/m³ and no greater than about 100 kg/m³. In other embodiments, a second latex foam layer 122 having a density of at least about 50 kg/m³ and no greater than about 100 kg/m³ is utilized. In still other embodiments, a second latex foam layer 122 having a density of at least about 60 kg/m³ and no greater than about 100 kg/m³ is utilized. For example, the second layer 122 of latex foam illustrated in FIG. 2 has a density of no less than about 70 kg/m³.

In some embodiments, the second layer 126 of latex foam can increase the “bounce” of the body support 110 while still retaining the benefits of the visco-elastic foam in the first layer 122 as described above.

The illustrated embodiment of FIG. 2 further includes a third layer 130 that includes a third top surface 130a and a third bottom surface 130b. The third top surface 130a can be positioned adjacent the second bottom surface 126b, such that the third layer 130 supports the second layer 126. In some embodiments, the second layer 126 can rest upon the third layer 130 without being secured thereto. However, in other embodiments, the second and third layers 126, 130 are secured to one another by adhesive or cohesive bonding material, by being bonded together during formation of the second and third layers 126, 130, or in any of the other manners described above in connection with the first and second layers 122, 126. In the illustrated embodiment of FIG. 2, thin adhesive strips (not shown) are positioned between the second and third layers 126, 130 to secure the second and third layers 126, 130 together in a manner similar to that described above in connection with the first and second layers 122, 126.

The third layer 130 defines a third thickness t3 between the third top surface 130a and the third bottom surface 130b. In some embodiments, t3 is less than or equal to about 3 cm. In other embodiments, t3 is less than or equal to about 2 cm. In still other embodiments, t3 is less than or equal to about 1 cm. In some embodiments, t3 is substantially equal to t1 and/or t2.

In the illustrated embodiment of FIG. 2, both the third top surface 130a and the third bottom surface 130b are substantially planar. In other embodiments, at least one of the third top surface 130a and the third bottom surface 130b can be non-planar, including without limitation surfaces having ribs, bumps, and other protrusions of any shape and size, surfaces having grooves and other apertures that extend partially or fully through the third layer 130, and the like.

Also with reference to the illustrated embodiment of FIG. 2, the third layer 130 comprises a reticulated or non-reticulated visco-elastic foam, as was described in detail for the first layer 122. In this embodiment, the third layer 130 can have any of the density and hardness values as were described above for the first layer 122, and in some embodiments, can have the same density and/or hardness of the first layer 122.

The illustrated embodiment of FIG. 2 further includes a fourth layer 134 that includes a fourth top surface 134a and a fourth bottom surface 134b. The fourth top surface 134a can be positioned adjacent the third bottom surface 130b, such that the fourth layer 134 supports the third layer 130. In some embodiments, the third layer 130 can rest upon the fourth layer 134 without being secured thereto. However, in other embodiments, the third and fourth layers 130, 134 are secured to one another by adhesive or cohesive bonding material, by being bonded together during formation of the third and fourth layers 130, 134, or in any of the other manners described above in connection with the first and second layers 122, 126. In the illustrated embodiment of FIG. 2, thin adhesive strips (not shown) are positioned between the third and fourth layers 130, 134 to secure the third and fourth layers 130, 134 together in a manner similar to that described above in connection with the first and second layers 122, 126.

The fourth layer 134 defines a fourth thickness t4 between the fourth top surface 134a and the fourth bottom surface 134b. In some embodiments, t4 is less than or equal to about 3 cm. In other embodiments, t4 is less than or equal to about 3 cm. In still other embodiments, t4 is less than or equal to about 1 cm. In some embodiments, t4 is substantially equal to t1, t2 and/or t3.

In the illustrated embodiment, both the fourth top surface 134a and the fourth bottom surface 134b are substantially planar. In other embodiments, at least one of the fourth top surface 134a and the fourth bottom surface 134b can be non-planar, including without limitation surfaces having ribs, bumps, and other protrusions of any shape and size, surfaces having grooves and other apertures that extend partially or fully through the fourth layer 134, and the like.

Also with reference to the illustrated embodiment of FIG. 2, the fourth layer 134 comprises a high-resilience (HR) polyurethane foam. In some embodiments, the HR polyurethane foam can include any expanded polymer (e.g., expanded ethylene vinyl acetate, polypropylene, polystyrene, or polyethylene), and the like. The fourth layer 134 can have a hardness greater than about 80 N and no greater than about 200 N for a desirable overall body support firmness and “bounce” when used in conjunction with the layers of visco-elastic foam 122, 130 described above, and also when used in conjunction with the layer of latex foam 126 as described above. In other embodiments, a fourth layer 134 having a hardness of at least about 90 N and no greater than about 190 N is utilized for this purpose. In still other embodiments, a fourth layer 134 hardness of at least about 100 N and no greater than about 180 N is utilized.

The fourth layer 134 can also have a density providing a reasonable degree of material durability. Like the other layers of the body support 110, the density of the foam in the HR foam fourth layer 134 can impact other characteristics of the foam, such as the manner in which the fourth layer 134 responds to pressure. In some embodiments, the fourth layer 134 has a density of no less than about 10 kg/m³ and no greater than about 80 kg/m³. In other embodiments, a fourth layer 134 having a density of at least about 15 kg/m³ and no greater than about 70 kg/m³ is utilized. In still other embodiments, a fourth layer 134 having a density of at least about 20 kg/m³ and no greater than about 60 kg/m³ is utilized.

The illustrated embodiment of FIG. 2 further includes a fifth layer 138 that includes a fifth top surface 138a and a fifth bottom surface 138b. The fifth top surface 138a can be positioned adjacent the fourth bottom surface 134b, such that the fifth layer 138 supports the fourth layer 134. In some embodiments, the fourth layer 134 can rest upon the fifth layer 138 without being secured thereto. However, in other embodiments, the fourth and fifth layers 134, 138 are secured to one another by adhesive or cohesive bonding material, by being bonded together during formation of the fourth and fifth layers 134, 138, or in any of the other manners described above in connection with the first and second layers 122, 126. In the illustrated embodiment of FIG. 2, thin adhesive strips (not shown) are positioned between the fourth and fifth layers 134, 138 to secure the fourth and fifth layers 134, 138 together in a manner similar to that described above in connection with the first and second layers 122, 126.

The fifth layer 138 defines a fifth thickness t5 between the fifth top surface 138a and the fifth bottom surface 138b. In some embodiments, t5 is less than or equal to about 3 cm. In other embodiments, t5 is less than or equal to about 2 cm. In still other embodiments, t5 is equal to about 1 cm. In some embodiments, t5 is substantially equal to t1, t2, t3 and/or t4.

In the illustrated embodiment, both the fifth top surface 138a and the fifth bottom surface 138b are substantially planar. In other embodiments, at least one of the fifth top surface 138a and the fifth bottom surface 138b can be non-planar, including without limitation surfaces having ribs, bumps, and other protrusions of any shape and size, surfaces having grooves and other apertures that extend partially or fully through the fifth layer 138, and the like.

Also with reference to the illustrated embodiment of FIG. 2, the fifth layer 138 comprises a reticulated or non-reticulated visco-elastic foam, as was described in detail for the first layer 122. In this embodiment, the fifth layer 138 can have any of the density and hardness values as were described above for the first layer 122, and in some embodiments, can have the same density and/or hardness of the first layer 122.

The illustrated embodiment of FIG. 2 further includes a sixth layer 142 that includes a sixth top surface 142a and a sixth bottom surface 142b. The sixth top surface 142a can be positioned adjacent the fifth bottom surface 138b, such that the sixth layer 142 supports the fifth layer 138. In some embodiments, the fifth layer 138 can rest upon the sixth layer 142 without being secured thereto. However, in other embodiments, the fifth and sixth layers 138, 142 are secured to one another by adhesive or cohesive bonding material, by being bonded together during formation of the fifth and sixth layers 138, 142, or in any of the other manners described above in connection with the first and second layers 122, 126. In the illustrated embodiment of FIG. 2, thin adhesive strips (not shown) are positioned between the fifth and sixth layers 138, 142 to secure the fifth and sixth layers 138, 142 together in a manner similar to that described above in connection with the first and second layers 122, 126.

The sixth layer 142 defines a sixth thickness t6 between the sixth top surface 142a and the sixth bottom surface 142b. In some embodiments, t6 is less than or equal to about 3 cm. In other embodiments, t6 is less than or equal to about 2 cm. In still other embodiments, t6 is equal to about 1 cm. In some embodiments, t6 is substantially equal to t1, t2, t3, t4 and/or t5.

In the illustrated embodiment, both the sixth top surface 142a and the sixth bottom surface 142b are substantially planar. In other embodiments, at least one of the sixth top surface 142a and the sixth bottom surface 142b can be non-planar, including without limitation surfaces having ribs, bumps, and other protrusions of any shape and size, surfaces having grooves and other apertures that extend partially or fully through the sixth layer 142, and the like.

The sixth layer 142 comprises latex foam, as was described in detail for the second layer 126. In this embodiment, the sixth layer 142 can have any of the density and hardness values as were described above for the second layer 126, and in some embodiments, can have the same density and/or hardness of the second layer 126. The latex sixth layer 142 can further provide a desirable overall body support firmness and “bounce” when used in conjunction with the layers of visco-elastic foam 122, 130, and 138 described above, and also when used in conjunction with the latex second layer 126 and/or HR fourth layer 134 described above.

The illustrated embodiment of FIG. 2 further includes a seventh layer 146 that includes a seventh top surface 146a and a seventh bottom surface 146b. The seventh top surface 146a can be positioned adjacent the sixth bottom surface 142b, such that the seventh layer 146 supports the sixth layer 142. In some embodiments, the sixth layer 142 can rest upon the seventh layer 146 without being secured thereto. However, in other embodiments, the sixth and seventh layers 142, 146 are secured to one another by adhesive or cohesive bonding material, by being bonded together during formation of the sixth and seventh layers 142, 146, or in any of the other manners described above in connection with the first and second layers 122, 126. In the illustrated embodiment of FIG. 2, thin adhesive strips (not shown) are positioned between the sixth and seventh layers 142, 146 to secure the sixth and seventh layers 142, 146 together in a manner similar to that described above in connection with the first and second layers 122, 126.

The seventh layer 146 defines a seventh thickness t7 between the seventh top surface 146a and the seventh bottom surface 146b. In some embodiments, t7 is less than or equal to about 3 cm. In other embodiments, t7 is less than or equal to about 2 cm. In still other embodiments, t7 is equal to about 1 cm. In some embodiments, t7 is substantially equal to t1, t2, t3, t4, t5 and/or t6.

In the illustrated embodiment, both the seventh top surface 146a and the seventh bottom surface 146b are substantially planar. In other embodiments, at least one of the seventh top surface 146a and the seventh bottom surface 146b can be non-planar, including without limitation surfaces having ribs, bumps, and other protrusions of any shape and size, surfaces having grooves and other apertures that extend partially or fully through the seventh layer 146, and the like.

Also with reference to the illustrated embodiment of FIG. 2, the seventh layer 146 comprises a reticulated or non-reticulated visco-elastic foam, as was described in detail for the first layer 122. In this embodiment, the seventh layer 146 can have any of the density and hardness values as were described above for the first layer 122, and in some embodiments, can have the same density and/or hardness of the first layer 122.

The illustrated embodiment of FIG. 2 further includes an eighth layer 150 that includes an eighth top surface 150a and an eighth bottom surface 150b. The eighth top surface 150a can be positioned adjacent the seventh bottom surface 146b, such that the eighth layer 150 supports the seventh layer 146. In some embodiments, the seventh layer 146 can rest upon the eighth layer 150 without being secured thereto. However, in other embodiments, the seventh and eighth layers 146, 150 are secured to one another by adhesive or cohesive bonding material, by being bonded together during formation of the seventh and eighth layers 146, 150, or in any of the other manners described above in connection with the first and second layers 122, 126. In the illustrated embodiment of FIG. 2, thin adhesive strips (not shown) are positioned between the seventh and eighth layers 146, 150 to secure the seventh and eighth layers 146, 150 together in a manner similar to that described above in connection with the first and second layers 122, 126.

The eighth layer 150 defines an eighth thickness t8 between the eighth top surface 150a and the eighth bottom surface 150b. In some embodiments, t8 is less than or equal to about 8 cm. In other embodiments, t8 is less than or equal to about 5 cm. In still other embodiments, t8 is no greater than about 3 cm. Although other configurations are possible, in the illustrated embodiment, t8 is greater than t1, t2, t3, t4, t5, t6 and t7.

In the illustrated embodiment, the eighth top surface 150a includes convolutions, whereas the eighth bottom surface 150b is substantially planar. In other embodiments, both the eighth top surface 150a and the eighth bottom surface 150b can be non-planar (e.g., can have similar or different convolutions or other non-planar features, including without limitation surfaces having ribs, bumps, and other protrusions of any shape and size, surfaces having grooves and other apertures that extend partially or fully through the eighth layer 150, and the like). The spaces defined by the convolutions on the eighth top surface 150a of the eighth layer 150 define passageways between the seventh and eighth layers 146, 150. The passageways permit movement of air between the seventh and eighth layers 146, 150, thereby improving heat transfer within the body support 110. Also or alternatively, heat in one or more locations of the body support 110 can be dissipated into and through the passageways between the seventh and eighth layers 146, 150. The improved heat transfer enabled by the passageways can be used to cool both seventh and eighth layers 146, 150, and can be particularly useful in reducing heat in the layers 122, 126, 130, 134, 138, 142, and 146 closest to the user.

The eighth layer 150 comprises latex foam, as was described in detail for the second layer 126. In this embodiment, the eighth layer 150 can have any of the density and hardness values as were described above for the second layer 126, and in some embodiments, can have the same density and/or hardness of the second layer 126. The latex eighth layer 150 can further provide a desirable overall body support firmness and “bounce” when used in conjunction with the layers of visco-elastic foam 122, 130, 138, and 146 described above, and also when used in conjunction with the latex second and sixth layers 126, 142 and/or HR fourth layer 134 described above.

The illustrated embodiment of FIG. 2 further includes a ninth layer 154 that includes a ninth top surface 154a and a ninth bottom surface 154b. In the illustrated embodiment, the ninth bottom surface 154b is also the body support bottom surface 118. In other embodiments, one or more additional layers or pads can be included below the ninth bottom surface 154b and the body support bottom surface 118. The ninth top surface 154a can be positioned adjacent the eighth bottom surface 150b, such that the ninth layer 154 supports the eighth layer 150. In some embodiments, the eighth layer 150 can rest upon the ninth layer 154 without being secured thereto. However, in other embodiments, the eighth and ninth layers 150, 154 are secured to one another by adhesive or cohesive bonding material, by being bonded together during formation of the eighth and ninth layers 150, 154, or in any of the other manners described above in connection with the first and second layers 122, 126. In the illustrated embodiment of FIG. 2, thin adhesive strips (not shown) are positioned between the eighth and ninth layers 150, 154 to secure the eighth and ninth layers 150, 154 together in a manner similar to that described above in connection with the first and second layers 122, 126.

The ninth layer 154 defines a ninth thickness t9 between the ninth top surface 154a and the ninth bottom surface 154b. In some embodiments, t9 is less than or equal to about 10 cm. In other embodiments, t9 is less than or equal to about 8 cm. In still other embodiments, t9 is no greater than about 5 cm. Although other configurations are possible, in the illustrated embodiment, t9 is greater than t1, t2, t3, t4, t5, t6, t7 and t8.

In the illustrated embodiment, the ninth top surface 154a includes convolutions, whereas the ninth bottom surface 154b is substantially planar. In other embodiments, both the ninth top surface 154a and the ninth bottom surface 154b can be non-planar (e.g., can have similar or different convolutions or other non-planar features, including without limitation surfaces having ribs, bumps, and other protrusions of any shape and size, surfaces having grooves and other apertures that extend partially or fully through the ninth layer 154, and the like. The spaces defined by the convolutions on the ninth top surface 154a of the ninth layer 154 define passageways between the eighth and ninth layers 150, 154. The passageways permit movement of air between the eighth and ninth layers 150, 154, thereby improving heat transfer within the body support 110. Also or alternatively, heat in one or more locations of the body support 110 can be dissipated into and through the passageways between the eighth and ninth layers 150, 154. The improved heat transfer enabled by the passageways can be used to cool both eighth and ninth layers 150, 154, and can be particularly useful in reducing heat in the layers 122, 126, 130, 134, 138, 142, 146, 150 closest to the user.

The ninth layer 154 comprises HR polyurethane foam, as was described in detail for the fourth layer 134. In this embodiment, the ninth layer 154 can have any of the density and hardness values as were described above for the fourth layer 134, and in some embodiments, can have the same density and/or hardness of the fourth layer 134. The HR ninth layer 154 can further provide a desirable overall body support firmness and “bounce” when used in conjunction with the layers of visco-elastic foam 122, 130, 138, 146 described above, and also when used in conjunction with the latex second and sixth layers 126, 142 and/or the HR fourth layer 134 described above.

Although not subscribing to any theory or scientific principle by which the performance of the body support 110 described above is defined, it is believed that the use of multiple layers of relatively thin visco-elastic foam (the properties of which are described above) alternating in stacked relation with layers of non-visco-elastic foam (such as latex and/or HR foam, the properties of which are also described above) results in a body support 110 having the low-resilience, soft feel, and body-conforming properties of visco-elastic foam while still having the higher “bounce” or recoil of a conventional body support to which many users have become accustomed. Accordingly, in some embodiments, the use of such thin alternating visco-elastic foam layers with non-visco-elastic foam layers can limit or attenuate the feeling of sinking into the body support that is normally experienced with body supports having thicker visco-elastic foam layers. Although the first seven layers 122, 126, 130, 134, 138, 142, 146 described above are each described has having thicknesses no greater than 3cm in some embodiments, 2 cm in other embodiments, and 1 cm in other embodiments, particularly desirable overall body support properties are achieved in those embodiments in which one or more of these layers is no greater than 2 cm in thickness, whereas other desirable overall body support properties are achieved in those embodiments in which one or more of these layers is no greater than 1 cm in thickness. In this regard, such properties can be achieved in some embodiments where at least half of the layers of the body support 110 are no greater than about 2 cm and 1 cm in thickness, respectively. This stands in contrast to conventional multi-layered foam body supports, in which it was typically believed that much thicker layers of particular foams were necessary to achieve particular firmness, recoil, “bounce”, body conforming, softness, and other cushion properties.

Although a particular body support structure in which thin layers of visco-elastic foam alternate with thin layers of non-visco-elastic (e.g., latex and/or HR) foam is described above and illustrated in FIGS. 1 and 2, it will be appreciated that some changes may be made to the overall structure which still falling within the spirit and scope of the present invention (including the feature of alternating thin visco-elastic layers). For example, in some alternative embodiments of the present invention, any one, two, or three of the layers of latex foam 126, 142, 150 can be replaced by HR foam or with another type of non-visco-elastic foam. In such embodiments, the HR or other type of foam can have density and/or firmness properties that are similar to the latex foam layers 126, 142, 150 described above, and can also have the same thicknesses described above with regard to the latex foam layers 126, 142, 150. Similarly, in some alternative embodiments of the present invention, either or both layers of HR foam 134, 154 can be replaced by latex foam or with another type of non-visco-elastic foam. In such embodiments, the latex or other type of foam can have density and/or firmness properties that are similar to the HR foam layers 134, 154 described above, and can also have the same thicknesses described above with regard to the HR foam layers 134, 154.

It will also be appreciated that visco-elastic foam layers in the body support 110 need not necessarily be separated solely by a single layer of another type of foam (e.g., latex, HR, and the like). Two or more layers of the same or different non-visco-elastic foam can be located between any of the two successive visco-elastic layers 122, 130, 138, 146. For example, any single layer of latex or HR foam 126, 134, 142, 154 described above can be replaced by two layers of the same latex or HR foam together having the same overall thickness (or greater thickness, in other embodiments). As another example, any single layer of latex or HR foam 126, 134, 142, 154 described above can be replaced by two layers of the same type of foam (two adjacent layers of latex foam, or two adjacent layers of HR foam) having different properties and together having the same overall thickness (or greater thickness, in some embodiments). As other examples, a layer of HR foam can be located between the first and second layers 122, 126, between the second and third layers 126, 130, between the fifth and sixth layers 138, 142, and/or between the sixth and seventh layers 146, 150 described above. Any such additional layers can each have the same thickness, surface shape, hardness, and density properties described above in connection with the fourth layer 134 of the illustrated embodiment. Also, a layer of latex foam can be located between the third and fourth layers 130, 134 and/or between the fourth and fifth layers 134, 138 described above. Any such additional layers can each have the same thickness, surface shape, hardness, and density properties described above in connection with the second and sixth layers 126, 146 of the illustrated embodiment.

As described above, the use of thin layers of visco-elastic foam alternating in stacked relationship with thin latex, HR, or other non-visco-elastic foam layers presents a unique feel of the body support (e.g., recoil or “bounce” of the body support) that would otherwise not be possible in body supports having thicker visco-elastic foam layers and/or body supports not having such an alternating stacked structure. In this regard, the body support 110 illustrated in FIG. 2 was tested for hardness as an entire structure. Using the same firmness measuring method described above, the body support 110 was found to have an overall hardness of 241.2 N. By varying the thickness of the visco-elastic foam layers, the thickness of the non-visco-elastic foam layers, the firmness of the visco-elastic foam layers, the firmness of the non-visco-elastic foam layers, the density of the visco-elastic foam layers, and/or the density of the non-visco-elastic foam layers (while still preferably remaining in the numerical ranges described above), the body support 110 can have an overall hardness of at least about 200 N and no greater than about 280 N for desirable softness, body-conforming, recoil, and “bounce” qualities. In other embodiments, any or all of these parameters can be adjusted to result in a body support 110 having an overall hardness of at least about 210 N and no greater than about 270 N. In still other embodiments, any or all of these parameters can be adjusted to result in a body support 110 having an overall hardness of at least about 220 and no greater than about 260 N.

The body support 110 illustrated in FIGS. 1 and 2 is presented in the form of a mattress. However, it will be appreciated that the features of the body support 110 described above are applicable to any other type of body support having any size and shape. By way of example only, any of the features described above are equally applicable to mattress toppers, overlays, futons, sleeper sofas, seat cushions, seat backs, neck pillows, leg spacer pillows, eye masks, and any other element used to support or cushion any part or all of a human or animal body. Accordingly, as used herein, the term “body support” is intended to refer to any and all of such elements (in addition to mattresses).

FIG. 3 illustrates another embodiment of a body support according to the present invention. This embodiment employs much of the same structure and has many of the same properties as the embodiments of the body support described above in connection with FIG. 2. Accordingly, the following description focuses primarily upon the structure and features that are different than the embodiments described above in connection with FIG. 2. Reference should be made to the description above in connection with FIG. 2 for additional information regarding the structure and features, and possible alternatives to the structure and features of the body support illustrated in FIG. 3 and described below. Structure and features of the embodiment shown in FIG. 3 that correspond to structure and features of the embodiment of FIG. 2 are designated hereinafter in the 200 series of reference numbers.

The body support 210 illustrated in FIG. 3 is substantially the same as that described above and illustrated in FIG. 2, but with two primary exceptions. First, the top (first) layer 222 of the body support 210 in FIG. 3 is thicker than that of the embodiment shown in FIG. 2. Although the first layer 222 still comprises reticulated or non-reticulated visco-elastic foam as described in connection with the embodiment of FIG. 2, the thickness t10 of the first layer 222 is larger than each of the second through seventh layers 226, 230, 234, 238, 242, 246. In other embodiments, the thickness t10 is only larger than a subset of each of the second through seventh layers 226, 230, 234, 238, 242, 246. In some embodiments, the thickness t10 of the first layer 222 is no less than about 2 cm. This thicker first layer 222 provides the body support 210 with more significant body conforming and pressure distributing properties than that shown in FIG. 1, based upon the use of a thicker visco-elastic first layer 222. However, the enhanced support, recoil, and “bounce” properties of the body support 210 are largely or completely retained by use of the underlying layers 226, 230, 234, 238, 242, 246, 250, 254 as described above in connection with FIG. 2. The thickness of the first layer 222 can therefore be selected to essentially “tune” the body support 210 to have any desired feel of a conventional visco-elastic foam body support (i.e., the feel by the user of the body conforming and pressure-distributing properties of visco-elastic foam), while still maintaining the benefits of the thin-layered alternating structure described above.

A second difference between the body support 210 shown in FIG. 3 and that shown in FIG. 2 is the use of a different visco-elastic foam for the first layer 222. In particular, the visco-elastic foam of the first layer 222 is different from that of the other visco-elastic foam layers 230, 238, 246. Although the visco-elastic foam of the first layer 222 can have the same density and hardness as the visco-elastic foam of the other visco-elastic foam layers 230, 238, 246, other properties of the visco-elastic foam of the first layer 222 can be different, such as tactile feel. In other embodiments, the visco-elastic foam of the first layer 222 has a different hardness and/or density than that of the other visco-elastic foam layers 230, 238, 246, while still falling within the hardness and density ranges described above in connection with the first illustrated embodiment. The use of visco-elastic foam layers 222, 230, 238, 246 having different types of visco-elastic foam (i.e., with one or more different properties) enables the body support manufacturer to make adjustments to the properties of the body support 210 at different depths of the body support 210.

The differences between the body supports 110, 210 described above resulted in a different overall body support hardness for the second body support 210. Using the same firmness measuring method described above, the body support 110 was found to have an overall hardness of 263.7 N. As described above in connection with the first illustrated embodiment, by varying the thickness of the visco-elastic foam layers, the thickness of the non-visco-elastic foam layers, the firmness of the visco-elastic foam layers, the firmness of the non-visco-elastic foam layers, the density of the visco-elastic foam layers, and/or the density of the non-visco-elastic foam layers (while still preferably remaining in the numerical ranges described above), the overall hardness of the body support 110 can be adjusted as desired. In this manner, the overall hardness of the body support 110 can be selected to fall within any of the overall body support hardness ranges described above.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. By way of example only, the various body support embodiments described and/or illustrated herein are presented as having a particular number of alternating thin layers of visco-elastic foam and non-visco-elastic foam atop other layers of the body support. Although unique and desirable properties result from such structures, body supports according to other embodiments of the present invention have less or more layers than those described and illustrated herein.

What is claimed is:

1. A body support assembly comprising:
a first layer comprising a visco-elastic foam;
a second layer supporting the first layer and comprising a non-visco-elastic foam; and
a third layer supporting the second layer and comprising a visco-elastic foam.

2. A body support assembly as defined in claim 1, wherein the visco-elastic foam of the first layer comprises non-reticulated, visco-elastic foam.

3. A body support assembly as defined in claim 1, wherein the non-visco-elastic foam of the second layer comprises latex foam.

4. A body support assembly as defined in claim 1, wherein the visco-elastic foam of the third layer comprises non-reticulated, visco-elastic foam.

5. A body support assembly as defined in claim 1, wherein the body support assembly has a total thickness, and wherein a thickness of the first layer is less than 20% of the total thickness.

6. A body support assembly as defined in claim 1, wherein the body support assembly has a total thickness, and wherein a thickness of the first layer is less than 10% of the total thickness.

7. A body support assembly as defined in claim 1, wherein the body support assembly has a total thickness, and wherein a thickness of each visco-elastic layer is less than 20% of the total thickness.

8. A body support assembly as defined in claim 1, wherein the body support assembly has a total thickness, and wherein a combined thickness of all visco-elastic layers is less than 50% of the total thickness.

9. A body support assembly as defined in claim 1, wherein a thickness of the first layer is less than 3 centimeters.

10. A body support assembly as defined in claim 1, wherein a thickness of the first layer is no more than 2 centimeters.

11. A body support assembly as defined in claim 1, wherein a thickness of each visco-elastic layer is no more than 2 centimeters.

12. A body support assembly comprising:
a first layer comprising non-reticulated, visco-elastic foam;
a second layer supporting the first layer and comprising a material different than non-reticulated, visco-elastic foam;
a third layer supporting the second layer and comprising visco-elastic foam;
a fourth layer supporting the third layer and comprising a material different than non-reticulated, visco-elastic foam; and
a fifth layer supporting the fourth layer and comprising visco-elastic foam.

13. A body support assembly as defined in claim 12, wherein the material of the second layer comprises a latex foam.

14. A body support assembly as defined in claim 12, wherein the visco-elastic foam of the third layer comprises non-reticulated, visco-elastic foam.

15. A body support assembly as defined in claim 12, wherein the material of the fourth layer comprises a high-resiliency foam.

16. A body support assembly as defined in claim 12, wherein the body support assembly has a total thickness, and wherein a thickness of the first layer is less than 20% of the total thickness.

17. A body support assembly as defined in claim 12, wherein the body support assembly has a total thickness, and wherein a thickness of the first layer is less than 10% of the total thickness.

18. A body support assembly as defined in claim 12, wherein the body support assembly has a total thickness, and wherein a thickness of each visco-elastic layer is less than 20% of the total thickness.

19. A body support assembly as defined in claim 12, wherein the body support assembly has a total thickness, and wherein a combined thickness of all visco-elastic layers is less than 50% of the total thickness.

20. A body support assembly as defined in claim 12, wherein a thickness of the first layer is less than 3 centimeters.
